(19) United States
(12) Patent Application Publication
(10) Pub. No.: US 2009/0047197 A1
(43) Pub. Date: Feb. 19, 2009

(54) Active material based bodies for varying surface texture and frictional force levels

(75) Inventors: Alan L. Browne, Grosse Pointe, MI (US); Nancy L. Johnson, Northville, MI (US); Nilesh D. Mankame, Ann Arbor, MI (US); Norman K. Bucknor, Troy, MI (US); Geoffrey P. Mc Knight, Los Angeles, CA (US); William Barvosa-Carter, Ventura, CA (US); Andrew C. Keefe, Encino, CA (US); Christopher P. Henry, Newbury Park, CA (US); Guillermo A. Herrera, Winnetka, CA (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/839,764

(22) Filed: Aug. 16, 2007

(51) Int. Cl. B01J 19/08; B01J 19/00

(52) U.S. Cl. 422/307; 422/243

(57) ABSTRACT

A device for selectively controlling and varying surface texture includes a body having at least one surface, and an active material in operative communication with the at least one surface, wherein the active material is configured to undergo a change in a property upon receipt of an activation signal, wherein the change in a property is effective to change a texture of the at least one surface.

### BACKGROUND

The present disclosure generally relates to methods and devices for selectively controlling and varying surface texture and/or frictional force levels on a surface.

Several devices or processes rely on the creation or elimination of a frictional force between opposing, contacting surfaces of two bodies to perform a specific function or operation. Exemplary devices having surfaces configured to produce or eliminate a frictional force include clutches, brakes (drum brakes, disc brakes, and the like), bearings, traction drives, devices that control fluid over or between surfaces, tires, mechanical seals, clamps, and the like. Many of these devices are either unable to control the frictional force level, or control the frictional force level by adjusting the speed of, or normal force exerted by, at least one of the contacting surfaces.

Moreover, friction exists at the surface of a body even without a second body in contact therewith. Fluid flow, airflow and/or drag create frictional forces over a surface, which can be increased or reduced by differences in the texture of the surface. Even further, aerodrag noise can be reduced or surface appearance changed by variances in surface texture.

Existing devices utilize actuators and motors to change relative speeds of and/or normal forces exerted by at least one of the contacting surfaces, as well as to change the frictional force levels and/or texture of a surface. For example, brake actuators can change a normal force between brake pads to change frictional force levels. Currently, aerodrag noise has been addressed on vehicle antennas by including a spiral wrap around the antenna. The change in surface texture of the antenna is effective to change the frequency of the noise generated by air flow over the surface of the antenna. However, the spiral wrap creates a permanent, rather than reversible texture for the antenna and can affect the antenna's ability to retract and deploy, as in the case of powered antennas for example.

Moreover, current devices for changing frictional force levels, however, can be expensive due to the high costs of separate actuators or motors. Further, other operational or functional requirements may not permit actuators and motors to be utilized to control frictional force levels.

Accordingly, there remains a need for improved devices and methods for varying the texture and frictional force levels of a surface.

### BRIEF SUMMARY

Disclosed herein are exemplary embodiments of devices and methods for selectively controlling and varying a surface texture with an active material based body. A device for selectively controlling and varying surface texture includes a body having at least one surface, and an active material in operative communication with the at least one surface, wherein the active material is configured to undergo a change in a property upon receipt of an activation signal, wherein the change in a property is effective to change a texture of the at least one surface.

A method for selectively controlling and varying surface texture, includes providing a body having at least one surface and an active material configured to undergo a change in a property upon receipt of an activation signal, wherein the change in a property is effective to change a texture of the at least one surface, and applying the activation signal to the active material and causing the change in the property of the active material, wherein the active material is in operative communication with the at least one surface and texturing the at least one surface with the change in the property of the active material.

The above described and other features are exemplified by the following figures and detailed description.

### BRIEF DESCRIPTION OF THE DRAWINGS

Referring now to the Figures, which are exemplary embodiments and wherein the like elements are numbered alike:

FIG. 1 is a schematic representation of an active material based body for varying surface texture and frictional force levels showing the active material based contact body with (a) a first surface texture and (b) a second surface texture;

FIG. 2 is a schematic representation of an active material based body for varying surface texture and frictional force levels showing the active material based body with (a) a first stiffness and (b) a second stiffness;

FIG. 3 is a schematic representation of an active material based body for varying surface texture and frictional force levels showing the active material based contact body with (a) a first surface texture and (b) a second surface texture;

FIG. 4 is another schematic representation of an active material based body for varying surface texture and frictional force levels showing the active material based body with (a) a first surface texture and (b) a second surface texture; and

FIG. 5 is a schematic representation of an active material based body for varying surface texture and frictional force levels showing the active material based body surface with (a) an active material layer having a first thickness and (b) the active material layer with a second thickness.

### DETAILED DESCRIPTION

Methods and devices for varying texture and controlling the frictional force of a surface are described herein. In contrast to the prior art, the methods and devices disclosed herein advantageously employ active materials to modify the texture of a surface. An active material component of the surface allows for control of the frictional force by varying the surface morphology of the active material component through a change in a property of the active material upon receipt of an activation signal. This change can be either reversible or permanent depending on the nature of the change in the active material and/or the existence of a biasing or return mechanism. The term “active material” as used herein generally refers to a material that exhibits a change in a property such as dimension, shape, orientation, shear force, elastic modulus, flexural modulus, yield strength, stiffness, and the like upon application of an activation signal. Suitable active materials include, without limitation, shape memory alloys (SMA), ferromagnetic shape memory alloys (MSMA), electroactive polymers (EAP), piezoelectric materials, magnetorheological (MR) elastomers, electrorheological (ER) elastomers, electrostrictive materials, magnetostrictive materials, and the like. Depending on the particular active material, the activation signal can take the form of, without limitation, an electric current, an electric field (voltage), a temperature change, a magnetic field, a mechanical loading or stressing (such as stress induced superelasticity in SMA), a chemistry or pH change, and the like.

Also, as used herein, the terms “first”, “second”, and the like do not denote any order or importance, but rather are used to distinguish one element from another, and the terms “the”, “a”, and “an” do not denote a limitation of quantity, but rather denote the presence of at least one of the referenced item. Furthermore, all ranges directed to the same quantity of a given component or measurement is inclusive of the endpoints and independently combinable.

In one embodiment, a device for selectively controlling and varying surface texture includes a body having at least one surface, and an active material in operative communication with the at least one surface, wherein the active material is configured to undergo a change in a property upon receipt of an activation signal, wherein the change in a property is effective to change a texture of the at least one surface. The change in the texture of the surface can include, without limitation, creation of a surface texture on an otherwise smooth surface and/or a change in scale, magnitude, shape, spacing, number, pattern, compliance characteristics and the like of the existing surface texture.

The devices for selectively controlling and varying surface texture and frictional force levels on a surface as disclosed herein may be used in any application adversely or beneficially affected by friction, such as traction devices, clutches, brakes, bearings, aerodynamics, clamps, and the like. Moreover, the active material based bodies can be employed for control of fluid boundary layer flow over surfaces. For example, airflow boundary layers, aero drag, and aero noise can be controlled by varying the texture of the surface through the use of active materials. This could be employed, for example, to alter the pressure forces on a vehicle and adjust the downforce applied to wheels to tailor performance to specific operating conditions. The texture can be varied to create turbulent or laminar boundary layer flow patterns over any variable texture surface. The active material based bodies can also be used to control noise generated by the flow of air over a surface. For example, a vehicle antenna comprising an active material surface can be configured to change the surface texture of the antenna upon receipt of an activation signal by the active material. The change in the surface texture, such as a roughening of the surface, is effective to reduce the noise generated by airflow over the surface of the antenna. In the case of a powered antenna, for example, the antenna can have a smooth first surface when stowed and while deploying. Once the antenna is fully deployed, however, the active material can be activated to create a rough textured antenna surface. Likewise, the active material based bodies can be used not only to reduce the noise of airflow over a surface, but also to control the reflection of sound in acoustic applications.

In yet another application, the active material based bodies for varying surface texture can be used to control the visual appearance and/or feel of a surface to provide haptic signals to a user. In other words, the appearance and/or feel of a surface can be altered/controlled through the use of the active material based bodies. For example, glare on a vehicle dashboard can be reduced by varying the surface texture of the dashboard to create a surface which diffuses or scatters the sunlight. Alternatively, the surface can be made temporarily highly reflective to help manage heat from radiation entering the vehicle when parked in the sun. In a haptic example, the texture of a control knob surface can be controlled, such that the feel of the knob changes in a user's hand when the knob reaches a predetermined desired position. The active material based bodies can be employed to passively indicate a certain temperature or exposure to a specified level of temperature or magnetic field strength of a surface. In other words, the active material based body can be configured to change a surface texture to indicate a hot surface or to show exposure of the surface to a high temperature. A change in the texture of the surface can be used to help separate and remove coatings, deposits, and contaminants (such as ice) from the surface. The change in the texture of the surface can be used to help reduce the intimacy of contact between the surface and a second surface, uses including, but not limited to, permitting gas or liquid flow through a normally sealed interface such as for cooling or ventilation purposes.

These are just some of the many examples where the ability to adjust the frictional forces and/or vary the texture of a surface would be advantageous. Other applications, which could advantageously make use of the active material based body embodiments and methods disclosed below, will be known to those skilled in the art, and can include without limitation, haptic steering wheel feedback, haptic elevator floor wherein texture indicates floor number, and the like. Any platform configuration where the user is already in contact with a surface and one wants to create communication or feedback through that surface. In addition, it is to be understood that the surface texture and/or frictional force levels of the surface is controlled by active materials in communication with the body having the surface. Moreover, while certain methods were described with reference to specific active materials, it is to be understood that any active material may be capable of use for a certain application and method and may depend on the physical characteristics of the materials. The active materials may also take any physical form, such as, for example, porous, solid, embedded in second material (randomly or oriented), laminate, solid, lattice, particles, fibers, and the like.

The active material may change at least one property in response to an activation signal, and revert back to the original state of the at least one property upon discontinuation of the activation signal, or, for the classes of active materials that do not automatically revert upon discontinuation of the activation signal, alternative means can be employed to revert the active materials to their original state. In this manner, the active material based bodies function to adjust to changing conditions while increasing device simplicity and reducing the number of failure modes. As an example of an application where reversion back to the active material's original state is not advantageous, an SMP based body could be used. The SMP based body has a dimple textured surface in its memory state. Upon activation of a heat signal, the SMP dramatically softens and the surface texture can be flattened by pressing the textured surface against a flat surface. Cooling while holding the surfaces in contact locks in the flattened surface geometry on the SMP based body due to the accompanying dramatic increase in the modulus of the SMP. Reapplication of the heat signal with the surface loading removed would be required to return the SMP to the original dimpled surface. In another example, the active material based body can be a shaft configured for sliding into a vehicle hub. In its original state, the shaft could have a diameter smaller than the hub so that it can easily be installed within the hub. Once properly positioned within the hub, an activation signal can be applied to the active material of the shaft. The change in at least one property of the active material can be effective to expand or texture the surface of the shaft within the hub, thereby changing the surface of the shaft, and creating an interlocking fit with the hub. Upon discontinuation of the activation signal, the active material maintains the new, expanded surface.

The activation of the active materials can also be configured to vary with time. Moreover, the time-varying activation can occur continuously, wherein the active material changes property with the time variation of the activation signal, as opposed to non-varying activation wherein the active material changes property between two discrete states at activation. The above-listed suitable active materials for use in the active material based bodies will be discussed in greater detail below.

Coupled to and in operative communication with the active material based body is an activation device, which can be linked to a control system. The activation device is operable to selectively provide an activation signal to the active material based body and change a texture or frictional force of a surface by changing at least one property of the active material. The activation device can be configured to control the nature of the change in the at least one property of the active material, and, therefore, the change in the surface texture of the active material based body. Examples of the controllable nature of the change include, without limitation, a change in scale, a change in magnitude, a change in shape, a change in spacing, a change in pattern, a change in number, a change in compliance characteristics, and like changes in the texture of the surface of the active material based body. For example, the active material can vary the surface texture of the active material based body depending on whether one turns a knob to a desired position. The activation device, on demand, provides the activation signal or stimulus to the active material of the active material based body to cause the change in a feature, such as but not limited to, texture, appearance, frictional force, and the like, of at least a portion of surface of the body. In one embodiment, the change in feature generally remains for the duration of the applied activation signal. Upon discontinuation of the activation signal, the active material generally reverts to a deactivated form and returns substantially to the original at least one property, thus reverting the active material based body, and therefore its surface, to the original feature and/or features. In another embodiment, the change in at least one property of the active material and/or feature of at least a portion of the active material based body may remain upon discontinuing the activation signal. The embodiments described below are exemplary only and are not intended to be limited to any particular shape, size, dimension or configuration, material, or the like.

Alternatively, the activation signal can be applied to the active material passively, rather than through the use of an activation device. In this manner, the activation signal can be provided by the environment in which the active material based body is disposed. A surface texture can therefore be passively activated. In the case of ferromagnetic SMA or magnetostrictive materials in general, exposure to a magnetic field will cause dimensional changes in these active materials which if suitably arranged or configured will result in either the increase or decrease in surface texture. In the case of thermally activated shape memory materials, e.g. SMP or SMA, the thermally activated shape memory effect can be activated when exposed to a temperature above a prescribed limit. Examples of applications where passive activation can be beneficial include indicating contents of an active material based container (e.g., food containers, medicine containers, and the like) have spoiled and are unsuitable for further use, wherein a surface texture changes when an SMP or SMA is exposed to a temperature above a prescribed limit. In another example, an active material based body, such as a vehicle hood, is comprised of an SMP and has a first surface texture. The SMP can be configured such that heat from the engine can be effective to change, i.e., soften the SMP when a desired temperature is reached, thereby resulting in a change from the first surface texture to the second surface texture.

Several embodiments of the active material based devices and methods for selectively controlling and varying surface texture are disclosed below. In each of the figures, the particular embodiment is shown with the active material component in both an (a) activated state and (b) a deactivated state for ease in discussion and understanding the function of the particular application.

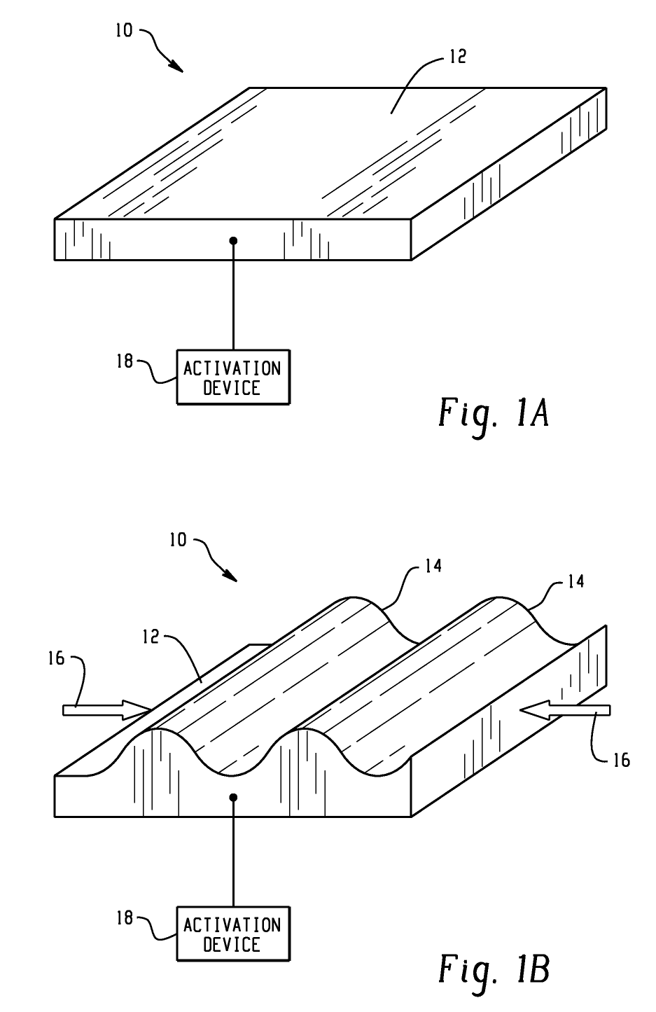

Referring now to FIG. 1, an exemplary active material based body 10 for selectively controlling and varying surface texture is illustrated. The body 10 has a surface 12 comprising an active material, as shown in FIG. 1(a). When the active material is activated, a change in at least one property, e.g., a shape change of the active material occurs, which results in a change in the texture of the surface 12. In this embodiment, the change in a shape of the active material results in wrinkles 14 forming on the surface 12, as shown in FIG. 1(b). Optional shear forces 16 may be applied to the edges of the surface 12 to further change the scale or the alignment of the wrinkles 14 depending on the direction and magnitude of the shear forces 16. Moreover, the wrinkles 14 change the intrinsic frictional coefficient of the body 10 when contacted by another body. Additionally, this embodiment may make use of another layer (not shown), located on top of the active material, which servers to communicate with the outside forces. This may act as a coating or be used to enhance the response and activity of the active material.

In an exemplary embodiment, the active material based body 10 can vary surface texture when the active material is activated upon receipt of an activation signal. In the embodiments disclosed herein, the activation signals may be active or passive. In FIG. 1, an activation device 18 provides an activation signal to the active material based body 10. The activation signal provided by the activation device 18 may include a heat signal, a magnetic signal, an electrical signal, a pneumatic signal, a mechanical signal, a chemical signal, and the like, and combinations comprising at least one of the foregoing signals, with the particular activation signal dependent on the materials and/or configuration of the active material. For instance, a heat signal may be applied for changing the property of the active material fabricated from SMA and/or SMP. An electrical signal may be applied for changing the property of the active material fabricated from EAP, electrostrictives, and/or electronic EAP's. A magnetic field may be applied (removed, or changed) for changing the property of the active material fabricated from magnetostrictive materials such as MSMA and MR elastomers.

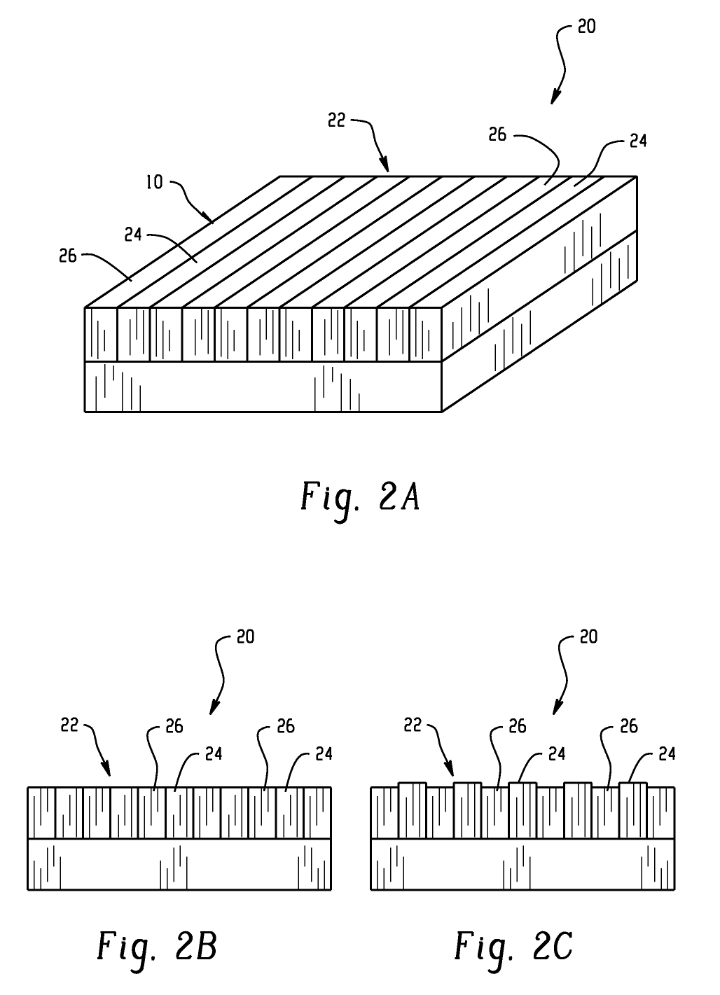

Turning now to FIG. 2, another embodiment of an active material based body 20 for selectively controlling and varying surface texture is illustrated. The body 20 is able to change the frictional coefficient of a surface 22 from an isotropic friction coefficient to an anisotropic friction coefficient through a change in at least one property of an active material component 24. As shown in FIG. 2(a), the body 20 comprises the surface 22, wherein the surface 22 comprises bands of active material components 24 and constant stiffness elements 26. The surface 22 has a first frictional coefficient (shown in FIG. 2(b)) when the active material component 24 have a first elastic modulus similar to that of the constant stiffness elements 26, such that the surface 22 of the body 20 is uniform resulting in an isotropic frictional coefficient. Moreover, the surface texture from active material component 24 to constant stiffness element 26 can be substantially uniform and provide a uniform frictional force between the surface and another body in contact therewith.

The surface 22 has a second frictional coefficient (shown in FIG. 2(c)) when the active material components 24 undergo the change in at least one property, i.e., a stiffness change, upon receipt of an activation signal. In this second elastic modulus, the active material components 24 have an elastic modulus lower than the constant stiffness elements 26. The constant stiffness elements 26, therefore, provide the primary frictional force between the surface and a body in contact therewith. In this condition, the surface has anisotropic constants due to the layout of the constant stiffness elements 26. When at this second stiffness level, the active material components 24 are capable of being deformed (plastically or through large elastic deformations) when contacted by a sufficient force. By engineering the regions of constant and variable stiffness, i.e. active material, elements, various types of anisotropic and isotopic frictional coefficients may be achieved. For example, a two dimensional corrugation could result in a relatively isotropic frictional coefficient, whereas a series of linear regions may yield an anisotropic friction coefficient. The surface 22 could even have a corrugated texture at the second stiffness level, thereby giving the surface 22 an anisotropic frictional coefficient. Specifically, changing the elastic modulus of the active material components 24 is effective to anisotropically change the frictional force level of the body 20. Therefore, the frictional force level, and in certain embodiments the texture, of the surface 22 will vary in alternating fashion from active material component 24 to constant stiffness element 26.

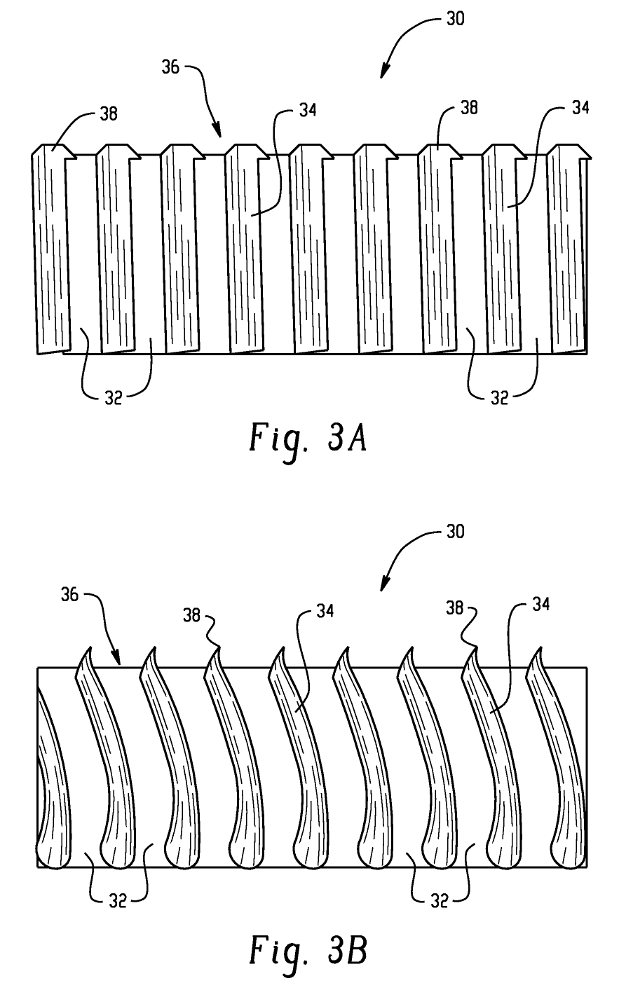

Referring to FIG. 3, another exemplary active material based body 30 is shown. The body 30 comprises an active material layer 32 and friction elements 34. The active material layer 32 is able to control frictional force levels and change the texture of the surface 36 by changing stiffness, and therefore shape, upon receipt of an activation signal. The active material layer 32 may be any of the active materials listed above. For example, in this embodiment SMP may be used as the active material layer 32, configured to transition shape when heated above a thermal transition temperature and when cooled below the thermal transition temperature. By changing stiffness and therefore compliance to the friction elements 34, the portion of friction elements that are exposed to the surface can be made to change. The frictional elements 34, having barbs 38, may comprise a resilient material, such as a bendable metal, and are secured in the SMP layer 32. Upon receipt of the activation signal, i.e., a thermal signal, the SMP layer 32 may be heated above a thermal transition temperature, thereby making the structure of the SMP layer 32 less rigid and allowing the friction elements 34 to return from a forced bent shape where the barbs 38 lay flat (as shown in FIG. 3(a)) to a relaxed natural position where the barbs 38 protrude from a surface 38 of the body 30 (as shown in FIG. 3(b)). When the SMP is cooled below the thermal transition temperature, the SMP layer 32 returns to a permanent, more rigid shape, thereby forcing the friction elements 34 to straighten. The deactivated SMP layer 32 bends the barbs 38 back into the surface 36 of the body 30. Therefore, when the activation signal is supplied to the SMP layer 32, the surface 36 changes shape from a substantially flat surface (FIG. 3(a)) to a surface having barbs 38 protruding therefrom (FIG. 3(b)). The reversible change in surface shape, changes the texture and frictional coefficient of the surface 36. In another exemplary embodiment, the friction elements 34 can be configured in the alternative, such that barbs 38 protrude from the SMP layer 32 when the SMP has a rigid structure, but do not protrude when the SMP is in a softened state.

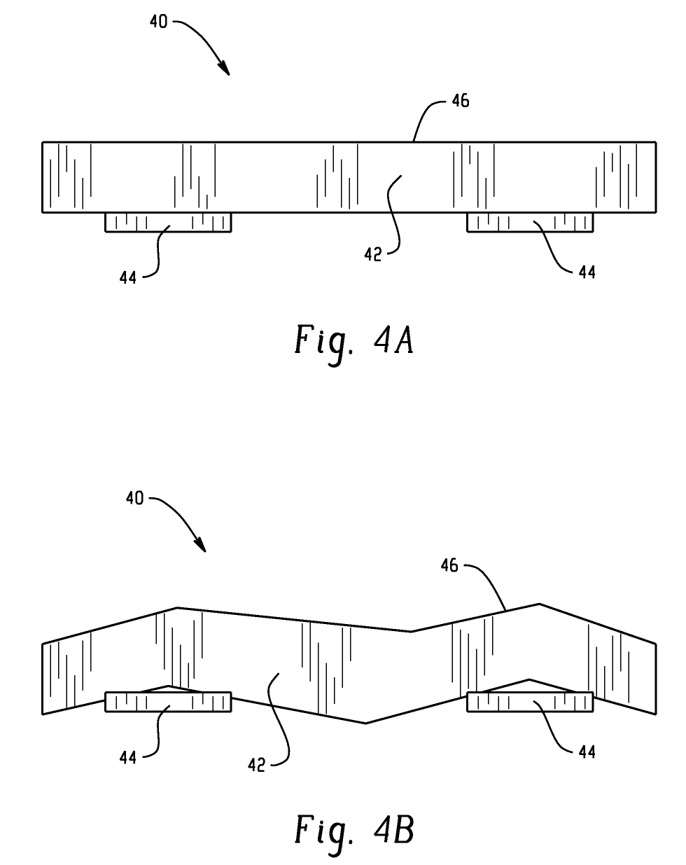

In FIG. 4, yet another embodiment of an active material based body 40 is illustrated. The body 40 is able to modify surface texture and control frictional force levels by inducing localized displacements and/or vibrations. The body 40 comprises a member 42 and active material components 44 in operative communication with the member. In this particular embodiment, the active material components 44 are patches of piezoelectric material disposed on the bottom surface of the member 42. The active material components 44, i.e., the piezoelectric patches, are configured to displace and/or vibrate at high frequency in response to the application of a voltage (constant or time varying, respectively). The member 42 comprises a flexible material with a surface 46. The displacements/vibrations of the piezoelectric patches 44 are effective to alter the texture and frictional force level of the surface 46. The member 42 is configured to transition between a first shape and a second shape in response to force supplied by the piezoelectric patches 44. The piezoelectric patches have piezoelectric layers off the neutral axis so that bending is produced when a voltage is applied and disappears when the voltage is removed. The electrical current supplies a standing electrical wave, which is a wave that remains in place and results in a vibration of the piezoelectric patches 44.

When the electrical signal is applied to the piezoelectric patches 44, the patches displace and/or vibrate and the member 42 transitions from a first shape (as shown in FIG. 4(a)) to a second shape (as shown in FIG. 4(b)). The change in shape of the first contact member 42 changes the frictional force levels and texture of the surface 46. The piezoelectric patches 44 and the surface 46 may be made to resonate in prescribed vibrational modes. These modes will create standing waves of displacement of the surface 46. The change in frictional force level of the surface 46 is dependant upon the current direction of the standing wave, which can change several times per second. The frictional force level, therefore, is directly induced by the localized displacement or vibrations of the piezoelectric patches 44 and they can be adjusted rapidly by changing the amplitude and relative frequency of the excitation to the piezoelectric patches 44, that in turn alters the displacement standing wave, the amplitude of the standing wave, and the like.

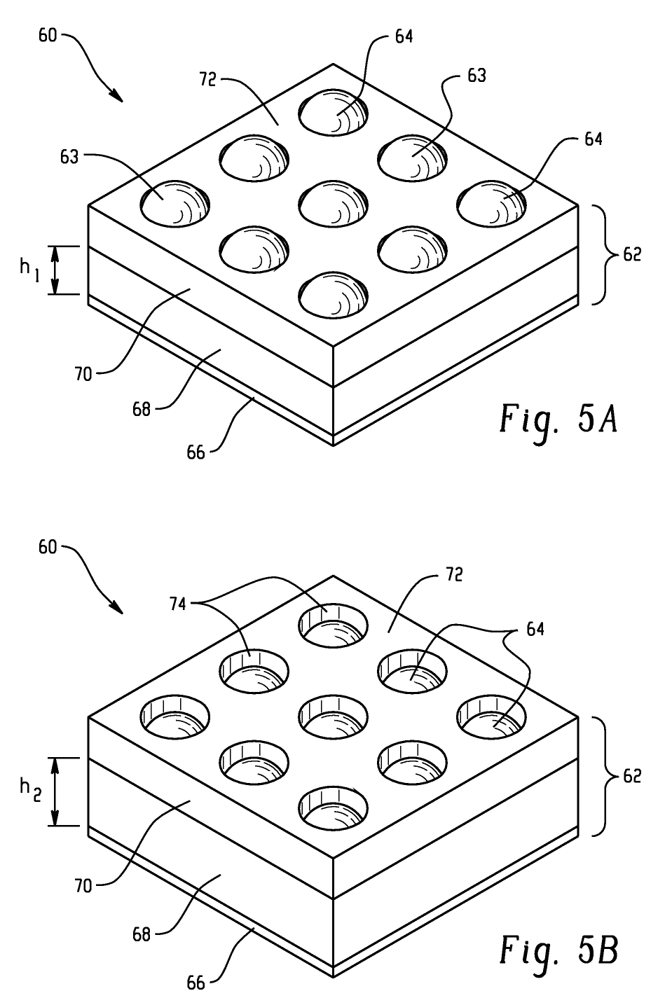

Turning now to FIG. 5, another exemplary active material based body 60 is illustrated. The body 60 is able to actively selectively vary the texture of a surface. In one particular embodiment, the body 60 comprises a multi-layer member 62 having friction elements, e.g., pins 64 embedded in the multi-layer member 62. The pins 64 have a first surface texture 63. The multi-layer member 62 is in physical communication with a substrate 66 and has a first layer 68 and a second layer 70. The first layer 68 comprises an active material, such as a SMA, configured to change shape in response to an activation signal, e.g., a thermal signal. The second layer 70 may be a non-active material or an active material different than that of the active material in the first layer 68. The second layer has a second surface texture 72, which has a frictional coefficient higher than that of the pins 64. In an alternative embodiment, the pins 64 may have a frictional coefficient higher than that of the surface 72.

When the active material first layer 68 has a first shape, as shown in FIG. 5 (a), the first layer 68 has a first thickness (h₁) and the pins 64 are exposed above the surface 72, such that a second body, a user's hand, airflow, and the like would frictionally engage the pins 64 when contacting the body 60. When the active material first layer 68 has a second shape, as shown in FIG. 5(b), the first layer 68 has a second thickness (h₂) and the pins 64 are disposed in recessed portions 74 of the second layer 70, such that the pins 64 are below the surface 72 and a second body a user's hand, airflow, and the like would frictionally engage the surface 72 when in physical communication with the body 60. In this embodiment, the pins 64 are comprised of a low-friction material and the second layer 70 comprises a material having a high-friction surface. The body 60, therefore, is able to variably select between two frictional surface textures by expanding and contracting the active material first layer 68 via an activation signal. When the active material first layer 68 has the first shape, the pins 64 provide a first coefficient of friction. When the active material first layer 68 has the second shape, the surface 72 of the second layer 70 provides a second coefficient of friction.

It is to be understood that the active material based body 60 is not limited to the specific shape shown in FIG. 5, rather the body can have any shape capable of changing in order to vary between the two frictional surface textures. In alternative exemplary embodiments, the friction elements 64 can have a surface with different surface textures at different portions of the surface. When the active material transitions shape, the friction elements 64 adjust to change the portions of the element facing the surface. For example, the body 60 may comprise a structure having rods as friction elements. The friction rods may have different frictional surfaces embedded parallel to the surface 72, such that activation of the active material would cause the rods to rotate, i.e., roll, from a position having a low-friction contact surface to a position having a high-friction contact surface. In yet another embodiment, the pins may actually comprise ball bearings and provide even greater changes in the frictional force of the surface.

Advantageously, the above disclosed methods for controlling the surface texture of an active material based body may be used in any application adversely or beneficially affected by friction, such as traction devices, clutches, brakes, bearings, aerodynamics, clamps, haptic systems, noise reduction, and the like. Other applications, which could advantageously make use of the above disclosed methods, will be known to those skilled in the art. In addition, it is to be understood that the texture and/or frictional force level of the surface can be controlled by active materials employed in, on, or about the body of the surface. Moreover, while certain methods were described with reference to specific active materials, it is to be understood that any active material may be capable of use for a certain method and may depend on the physical characteristics of the materials. The active materials may also take any physical form, such as, for example, porous, solid, embedded in second material (randomly or oriented), laminate, solid, lattice, and the like.

As previously mentioned, suitable active materials for the above described bodies, include, without limitation, shape memory polymers (SMP), shape memory alloys (SMA), magnetic shape memory alloys (MSMA), MR elastomers, piezoelectric materials, electroactive polymers (EAP), electrostictives as a class, and magnetostrictives as another class.

As previously described, suitable active materials for bodies that can vary surface texture and frictional force levels include, without limitation, shape memory alloys (“SMAs”; e.g., thermal and stress activated shape memory alloys and magnetic shape memory alloys (MSMA)), electroactive polymers (EAPs) such as dielectric elastomers, ionic polymer metal composites (IPMC), piezoelectric materials (e.g., polymers, ceramics), and shape memory polymers (SMPs), shape memory ceramics (SMCs), baroplastics, magnetorheological (MR) materials (e.g., fluids and elastomers), electrorheological (ER) materials (e.g., fluids, and elastomers), magnetostrictives, and electrostrictives and composites of the foregoing active materials with non-active materials, systems comprising at least one of the foregoing active materials, and combinations comprising at least one of the foregoing active materials. For convenience and by way of example, reference herein will be made to shape memory alloys and shape memory polymers. The shape memory ceramics, baroplastics, and the like, can be employed in a similar manner. For example, with baroplastic materials, a pressure induced mixing of nanophase domains of high and low glass transition temperature (Tg) components effects the shape change. Baroplastics can be processed at relatively low temperatures repeatedly without degradation. SMCs are similar to SMAs but can tolerate much higher operating temperatures than can other shape-memory materials. An example of an SMC is a piezoelectric material.

The ability of shape memory materials to return to their original shape upon the application or removal of external stimuli has led to their use in actuators to apply force resulting in desired motion. Active material actuators offer the potential for a reduction in actuator size, weight, volume, cost, noise and an increase in robustness in comparison with traditional electromechanical and hydraulic means of actuation. Ferromagnetic SMA's, for example, exhibit rapid dimensional changes of up to several percent in response to (and proportional to the strength of) an applied magnetic field. However, these changes are one-way changes and use the application of either a biasing force or a field reversal to return the ferromagnetic SMA to its starting configuration.

Shape memory alloys are alloy compositions with at least two different temperature-dependent phases or polarity. The most commonly utilized of these phases are the so-called martensite and austenite phases. In the following discussion, the martensite phase generally refers to the more deformable, lower temperature phase whereas the austenite phase generally refers to the more rigid, higher temperature phase. When the shape memory alloy is in the martensite phase and is heated, it begins to change into the austenite phase. The temperature at which this phenomenon starts is often referred to as austenite start temperature (As). The temperature at which this phenomenon is complete is often called the austenite finish temperature (Af). When the shape memory alloy is in the austenite phase and is cooled, it begins to change into the martensite phase, and the temperature at which this phenomenon starts is often referred to as the martensite start temperature (Ms). The temperature at which austenite finishes transforming to martensite is often called the martensite finish temperature (Mf). The range between As and Af is often referred to as the martensite-to-austenite transformation temperature range while that between Ms and Mf is often called the austenite-to-martensite transformation temperature range. It should be noted that the above-mentioned transition temperatures are functions of the stress experienced by the SMA sample. Generally, these temperatures increase with increasing stress. In view of the foregoing properties, deformation of the shape memory alloy is preferably at or below the austenite start temperature (at or below As). Subsequent heating above the austenite start temperature causes the deformed shape memory material sample to begin to revert back to its original (nonstressed) permanent shape until completion at the austenite finish temperature. Thus, a suitable activation input or signal for use with shape memory alloys is a thermal activation signal having a magnitude that is sufficient to cause transformations between the martensite and austenite phases.

The temperature at which the shape memory alloy remembers its high temperature form (i.e., its original, nonstressed shape) when heated can be adjusted by slight changes in the composition of the alloy and through thermo-mechanical processing. In nickel-titanium shape memory alloys, for example, it can be changed from above about 100° C. to below about −100° C. The shape recovery process can occur over a range of just a few degrees or exhibit a more gradual recovery over a wider temperature range. The start or finish of the transformation can be controlled to within several degrees depending on the desired application and alloy composition. The mechanical properties of the shape memory alloy vary greatly over the temperature range spanning their transformation, typically providing shape memory effect and superelastic effect. For example, in the martensite phase a lower elastic modulus than in the austenite phase is observed. Shape memory alloys in the martensite phase can undergo large deformations by realigning the crystal structure arrangement with the applied stress. The material will retain this shape after the stress is removed. In other words, stress induced phase changes in SMA are two-way by nature, application of sufficient stress when an SMA is in its austenitic phase will cause it to change to its lower modulus Martensitic phase. Removal of the applied stress will cause the SMA to switch back to its Austenitic phase, and in so doing, recovering its starting shape and higher modulus.

Exemplary shape memory alloy materials include nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-palladium based alloys, and so forth. The alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range of the intended application.

The recovery to the austenite phase at a higher temperature is accompanied by very large (compared to that needed to deform the material) stresses which can be as high as the inherent yield strength of the austenite material, sometimes up to three or more times that of the deformed martensite phase. For applications that require a large number of operating cycles, a strain of less than or equal to 4% or so of the deformed length of wire used can be obtained. In experiments performed with SMA wires of 0.5 millimeter (mm) diameter, the maximum strain in the order of 4% was obtained. This percentage can increase up to 8% for thinner wires or for applications with a low number of cycles. This limit in the obtainable strain places significant constraints in the application of SMA actuators where space is limited.

FSMAs are a sub-class of SMAs. FSMAs can behave like conventional SMAs materials that have a stress or thermally induced phase transformation between martensite and austenite. Additionally FSMAs are ferromagnetic and have strong magnetocrystalline anisotropy, which permit an external magnetic field to influence the orientation/fraction of field aligned martensitic variants. When the magnetic field is removed, the material may exhibit complete two-way, partial two-way or one-way shape memory. For partial or one-way shape memory, an external stimulus, temperature, magnetic field or stress may permit the material to return to its starting state. Perfect two-way shape memory may be used for proportional control with continuous power supplied. One-way shape memory is most useful for latching-type applications where a delayed return stimulus permits a latching function. External magnetic fields are generally produced via soft-magnetic core electromagnets in automotive applications, though a pair of Helmholtz coils may also be used for fast response.

Exemplary ferromagnetic shape memory alloys are nickel-manganese-gallium based alloys, iron-platinum based alloys, iron-palladium based alloys, cobalt-nickel-aluminum based alloys, cobalt-nickel-gallium based alloys. Like SMAs these alloys can be binary, ternary, or any higher order so long as the alloy composition exhibits a shape memory effect, e.g., change in shape, orientation, yield strength, flexural modulus, damping capacity, superelasticity, and/or similar properties. Selection of a suitable shape memory alloy composition depends, in part, on the temperature range and the type of response in the intended application.

As previously mentioned, other exemplary shape memory materials are shape memory polymers (SMPs). “Shape memory polymer” generally refers to a polymeric material, which exhibits a change in a property, such as a modulus, a dimension, a coefficient of thermal expansion, the permeability to moisture, an optical property (e.g., transmissivity), or a combination comprising at least one of the foregoing properties in combination with a change in its a microstructure and/or morphology upon application of an activation signal. Shape memory polymers can be thermoresponsive (i.e., the change in the property is caused by a thermal activation signal delivered either directly via heat supply or removal, or indirectly via a vibration of a frequency that is appropriate to excite high amplitude vibrations at the molecular level which lead to internal generation of heat), photoresponsive (i.e., the change in the property is caused by an electro-magnetic radiation activation signal), moisture-responsive (i.e., the change in the property is caused by a liquid activation signal such as humidity, water vapor, or water), chemo-responsive (i.e. responsive to a change in the concentration of one or more chemical species in its environment; e.g., the concentration of H+ ion—the pH of the environment), or a combination comprising at least one of the foregoing.

Generally, SMPs are phase segregated co-polymers comprising at least two different units, which can be described as defining different segments within the SMP, each segment contributing differently to the overall properties of the SMP. As used herein, the term “segment” refers to a block, graft, or sequence of the same or similar monomer or oligomer units, which are copolymerized to form the SMP. Each segment can be (semi-)crystalline or amorphous and will have a corresponding melting point or glass transition temperature (Tg), respectively. The term “thermal transition temperature” is used herein for convenience to generically refer to either a Tg or a melting point depending on whether the segment is an amorphous segment or a crystalline segment. For SMPs comprising (n) segments, the SMP is said to have a hard segment and (n−1) soft segments, wherein the hard segment has a higher thermal transition temperature than any soft segment. Thus, the SMP has (n) thermal transition temperatures. The thermal transition temperature of the hard segment is termed the “last transition temperature”, and the lowest thermal transition temperature of the so-called “softest” segment is termed the “first transition temperature”. It is important to note that if the SMP has multiple segments characterized by the same thermal transition temperature, which is also the last transition temperature, then the SMP is said to have multiple hard segments.

When the SMP is heated above the last transition temperature, the SMP material can be imparted a permanent shape. A permanent shape for the SMP can be set or memorized by subsequently cooling the SMP below that temperature. As used herein, the terms “original shape”, “previously defined shape”, “predetermined shape”, and “permanent shape” are synonymous and are intended to be used interchangeably. A temporary shape can be set by heating the material to a temperature higher than a thermal transition temperature of any soft segment yet below the last transition temperature, applying an external stress or load to deform the SMP, and then cooling below the particular thermal transition temperature of the soft segment while maintaining the deforming external stress or load.

The permanent shape can be recovered by heating the material, with the stress or load removed, above the particular thermal transition temperature of the soft segment yet below the last transition temperature. Thus, it should be clear that by combining multiple soft segments it is possible to demonstrate multiple temporary shapes and with multiple hard segments it can be possible to demonstrate multiple permanent shapes. Similarly using a layered or composite approach, a combination of multiple SMPs will demonstrate transitions between multiple temporary and permanent shapes.

The shape memory material may also comprise a piezoelectric material. Also, in certain embodiments, the piezoelectric material can be configured as an actuator for providing rapid deployment. As used herein, the term “piezoelectric” is used to describe a material that mechanically deforms (changes shape) when a voltage potential is applied, or conversely, generates an electrical charge when mechanically deformed. Piezoelectrics exhibit a small change in dimensions when subjected to the applied voltage, with the response being proportional to the strength of the applied field and being quite fast (capable of easily reaching the thousand hertz range). Because their dimensional change is small (e.g., less than 0.1%), to dramatically increase the magnitude of dimensional change they are usually used in the form of piezo ceramic unimorph and bi-morph flat patch actuators which are constructed so as to bow into a concave or convex shape upon application of a relatively small voltage. The morphing/bowing of such patches within the liner of the holder is suitable for grasping/releasing the object held.

One type of unimorph is a structure composed of a single piezoelectric element externally bonded to a flexible metal foil or strip, which is stimulated by the piezoelectric element when activated with a changing voltage and results in an axial buckling or deflection as it opposes the movement of the piezoelectric element. The actuator movement for a unimorph can be by contraction or expansion. Unimorphs can exhibit a strain of as high as about 10%, but generally can only sustain low loads relative to the overall dimensions of the unimorph structure.

In contrast to the unimorph piezoelectric device, a bimorph device includes an intermediate flexible metal foil sandwiched between two piezoelectric elements. Bimorphs exhibit more displacement than unimorphs because under the applied voltage one ceramic element will contract while the other expands. Bimorphs can exhibit strains up to about 20%, but similar to unimorphs, generally cannot sustain high loads relative to the overall dimensions of the unimorph structure.

Exemplary piezoelectric materials include inorganic compounds, organic compounds, and metals. With regard to organic materials, all of the polymeric materials with noncentrosymmetric structure and large dipole moment group(s) on the main chain or on the side-chain, or on both chains within the molecules, can be used as candidates for the piezoelectric film. Examples of polymers include poly(sodium 4-styrenesulfonate) (“PSS”), poly S-119 (Poly(vinylamine) backbone azo chromophore), and their derivatives; polyfluorocarbines, including polyvinylidene fluoride (“PVDF”), its co-polymer vinylidene fluoride (“VDF”), trifluorethylene (TrFE), and their derivatives; polychlorocarbons, including poly(vinylchloride) (“PVC”), polyvinylidene chloride (“PVC2”), and their derivatives; polyacrylonitriles (“PAN”), and their derivatives; polycarboxylic acids, including poly (methacrylic acid (“PMA”), and their derivatives; polyureas, and their derivatives; polyurethanes (“PU”), and their derivatives; bio-polymer molecules such as poly-L-lactic acids and their derivatives, and membrane proteins, as well as phosphate bio-molecules; polyanilines and their derivatives, and all of the derivatives of tetramines; polyimides, including Kapton® molecules and polyetherimide (“PEI”), and their derivatives; all of the membrane polymers; poly (N-vinyl pyrrolidone) (“PVP”) homopolymer, and its derivatives, and random PVP-co-vinyl acetate (“PVAc”) copolymers; and all of the aromatic polymers with dipole moment groups in the main-chain or side-chains, or in both the main-chain and the side-chains; as well as combinations comprising at least one of the foregoing.

Further, piezoelectric materials can include Pt, Pd, Ni, T, Cr, Fe, Ag, Au, Cu, and metal alloys comprising at least one of the foregoing, as well as combinations comprising at least one of the foregoing. These piezoelectric materials can also include, for example, metal oxide such as SiO2, Al2O3, ZrO2, TiO2, SrTiO3, PbTiO3, BaTiO3, FeO3, Fe3O4, ZnO, and combinations comprising at least one of the foregoing; and Group VIA and IIB compounds, such as CdSe, CdS, GaAs, AgCaSe2, ZnSe, GaP, InP, ZnS, and combinations comprising at least one of the foregoing.

Exemplary variable modulus materials also comprise magnetorheological (MR) and ER polymers. MR polymers are suspensions of micrometer-sized, magnetically polarizable particles (e.g., ferromagnetic or paramagnetic particles as described below) in a polymer (e.g., a thermoset elastic polymer or rubber). Exemplary polymer matrices include poly-alpha-olefins, natural rubber, silicone, polybutadiene, polyethylene, polyisoprene, and combinations comprising at least one of the foregoing.

The stiffness and potentially the shape of the polymer structure are attained by changing the shear and compression/tension moduli by varying the strength of the applied magnetic field. The MR polymers typically develop their structure when exposed to a magnetic field in as little as a few milliseconds, with the stiffness and shape changes being proportional to the strength of the applied field. Discontinuing the exposure of the MR polymers to the magnetic field reverses the process and the elastomer returns to its lower modulus state. Packaging of the field generating coils, however, creates challenges.

Electronic electroactive polymers (EAPs) are a laminate of a pair of electrodes with an intermediate layer of low elastic modulus dielectric material. Applying a potential between the electrodes squeezes the intermediate layer causing it to expand in plane. They exhibit a response proportional to the applied field and can be actuated at high frequencies. EAP morphing laminate sheets have been demonstrated. Their major downside is that they require applied voltages approximately three orders of magnitude greater than those required by piezoelectrics.

Electroactive polymers include those polymeric materials that exhibit piezoelectric, pyroelectric, or electrostrictive properties in response to electrical or mechanical fields. An example of an electrostrictive-grafted elastomer with a piezoelectric poly(vinylidene fluoride-trifluoro-ethylene) copolymer. This combination has the ability to produce a varied amount of ferroelectric-electrostrictive molecular composite systems.

Materials suitable for use as an electroactive polymer may include any substantially insulating polymer and/or rubber that deforms in response to an electrostatic force or whose deformation results in a change in electric field. Exemplary materials suitable for use as a pre-strained polymer include silicone elastomers, acrylic elastomers, polyurethanes, thermoplastic elastomers, copolymers comprising PVDF, pressure-sensitive adhesives, fluoroelastomers, polymers comprising silicone and acrylic moieties (e.g., copolymers comprising silicone and acrylic moieties, polymer blends comprising a silicone elastomer and an acrylic elastomer, and so forth).

Materials used as an electroactive polymer can be selected based on material propert(ies) such as a high electrical breakdown strength, a low modulus of elasticity (e.g., for large or small deformations), a high dielectric constant, and so forth. In one embodiment, the polymer can be selected such that is has an elastic modulus of less than or equal to about 100 MPa. In another embodiment, the polymer can be selected such that is has a maximum actuation pressure of about 0.05 megapascals (MPa) and about 10 MPa, or, more specifically, about 0.3 MPa to about 3 MPa. In another embodiment, the polymer can be selected such that is has a dielectric constant of about 2 and about 20, or, more specifically, about 2.5 and about 12. The present disclosure is not intended to be limited to these ranges. Ideally, materials with a higher dielectric constant than the ranges given above would be desirable if the materials had both a high dielectric constant and a high dielectric strength. In many cases, electroactive polymers can be fabricated and implemented as thin films, e.g., having a thickness of less than or equal to about 50 micrometers.

As electroactive polymers may deflect at high strains, electrodes attached to the polymers should also deflect without compromising mechanical or electrical performance. Generally, electrodes suitable for use can be of any shape and material provided that they are able to supply a suitable voltage to, or receive a suitable voltage from, an electroactive polymer. The voltage can be either constant or varying over time. In one embodiment, the electrodes adhere to a surface of the polymer. Electrodes adhering to the polymer can be compliant and conform to the changing shape of the polymer. The electrodes can be only applied to a portion of an electroactive polymer and define an active area according to their geometry. Various types of electrodes include structured electrodes comprising metal traces and charge distribution layers, textured electrodes comprising varying out of plane dimensions, conductive greases (such as carbon greases and silver greases), colloidal suspensions, high aspect ratio conductive materials (such as carbon fibrils and carbon nanotubes, and mixtures of ionically conductive materials), as well as combinations comprising at least one of the foregoing.

Exemplary electrode materials can include graphite, carbon black, colloidal suspensions, metals (including silver and gold), filled gels and polymers (e.g., silver filled and carbon filled gels and polymers), and ionically or electronically conductive polymers, as well as combinations comprising at least one of the foregoing. It is understood that certain electrode materials may work well with particular polymers and may not work as well for others. By way of example, carbon fibrils work well with acrylic elastomer polymers while not as well with silicone polymers.

Magnetostrictives are solids that develop a large mechanical deformation when subjected to an external magnetic field. This magnetostriction phenomenon is attributed to the rotations of small magnetic domains in the materials, which are randomly oriented when the material is not exposed to a magnetic field. The shape change is largest in ferromagnetic or ferromagnetic solids. These materials possess a very fast response capability, with the strain proportional to the strength of the applied magnetic field, and they return to their starting dimension upon removal of the field. However, these materials have maximum strains of about 0.1 to about 0.2 percent.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A device for selectively controlling and varying surface texture comprising:
a body having at least one surface; and
an active material in operative communication with the at least one surface, wherein the active material is configured to undergo a change in a property upon receipt of an activation signal, wherein the change in a property is effective to change a texture of the at least one surface.

2. The device of claim 1, wherein the active material comprises a shape memory polymer, a shape memory alloy, a ferromagnetic shape memory alloy, an electroactive polymer, a piezoelectric material, a magnetorheological elastomer, an electrorheological elastomer, an electrostrictive material, a magnetostrictive material, or a combination comprising at least one of the foregoing active materials.

3. The device of claim 1, wherein the change in the property comprises a dimensional change, a shape change, an orientation change, a flexural modulus change, an elastic modulus change, or combinations comprising at least one of the foregoing properties.

4. The device of claim 1, wherein the activation signal comprises a thermal activation signal, an electric activation signal, a magnetic activation signal, a chemical activation signal, a mechanical load, or a combination comprising at least one of the foregoing activation signals.

5. The device of claim 1, further comprising an activation device configured to provide the activation signal to the active material.

6. The device of claim 1, wherein the change in the texture of the at least one surface is effective to change an airflow boundary layer across the surface.

7. The device of claim 1, wherein the change in the texture of the at least one surface is effective to change a frictional coefficient between the surface and a contacting body.

8. The device of claim 1, wherein the change in the texture of the at least one surface is effective to provide a haptic signal.

9. The device of claim 1, wherein the change in the texture of the at least one surface is effective to reduce noise generated by a fluid flow over the at least one surface.

10. The device of claim 1, wherein the change in the texture of the at least one surface is effective to reduce glare on the at least one surface.

11. The device of claim 1, wherein the change in the texture of the at least one surface is effective to scatter and thus reduce sound reflected from the at least one surface.

12. The device of claim 1, wherein the change in the texture of the at least one surface is effective to separate and remove coatings, deposits, contaminants, and combinations comprising at least one of the forgoing from the at least one surface.

13. The device of claim 1, wherein the change in the texture of the at least one surface is effective to indicate the exposure of the at least one surface to a selected one or both of a temperature and magnetic field above a predetermined level.

14. The device of claim 1, wherein the change in the texture of the at least one surface is effective to reduce the contact between the at least one surface and a second surface to permit gas and/or liquid flow through an interface between the at least one surface and the second surface.

15. The device of claim 1, wherein the change in the texture of the at least one surface is effective to change the visual appearance of the at least one surface, wherein the change in the visual appearance is a transition between a smooth finish and a matte finish, an induction of a texturing pattern, and combinations comprising at least one of the foregoing.

16. The device of claim 1, wherein the body further comprises: a first layer comprising the active material, wherein the first layer is configured to change from a first thickness to a second thickness when the active material undergoes the change in a property, wherein the change in thickness is effective to raise and/or lower a surface texture.

17. A method for selectively controlling and varying surface texture, comprising:
providing a body having at least one surface and an active material configured to undergo a change in a property upon receipt of an activation signal, wherein the change in a property is effective to change a texture of the at least one surface; and
applying the activation signal to the active material and causing the change in the property of the active material, wherein the active material is in operative communication with the at least one surface and texturing the at least one surface with the change in the property of the active material.

18. The method of claim 16, further comprising discontinuing the activation signal and reversing the change in the texture of the at least one surface.

19. The method of claim 16, wherein the active material comprises a shape memory polymer, a shape memory alloy, a ferromagnetic shape memory alloy, an electroactive polymer, a piezoelectric material, a magnetorheological elastomer, an electrorheological elastomer, an electrostrictive, a magnetostrictive, or a combination comprising at least one of the foregoing active materials.

20. The method of claim 16, wherein the change in the property comprises a dimensional change, a shape change, an orientation change, a flexural modulus change, an elastic modulus change, or combinations comprising at least one of the foregoing properties.
